(19) United States
(12) Patent Application Publication
(10) Pub. No.: US 2005/0237671 A1
(43) Pub. Date: Oct. 27, 2005

(54) Head load/unload ramp mechanism for a disk drive

(75) Inventor: Long V. Nguyen, San Jose, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/080,001

(22) Filed: Mar. 15, 2005

Related U.S. Application Data
(60) Provisional application No. 60/564,345, filed on Apr. 21, 2004.

(51) Int. Cl. G11B 5/54

(52) U.S. Cl. 360/254.4

(57) ABSTRACT

One embodiment of the present invention is a disk drive including: (a) two heads for reading/writing data from/onto a disk; and (b) a ramp mechanism adapted to guide movement of the two heads to/from the disk; wherein the ramp mechanism comprises a separation feature having a portion that extends between the two heads.

This application claims the benefit of U.S. Provisional Application No. 60/564,345, filed on Apr. 21, 2004 and which is incorporated herein by reference.

### TECHNICAL FIELD OF THE INVENTION

One or more embodiments of the present invention relate to disk drives, and more particularly, to a read/write head load/unload ramp mechanism for disk drives.

### BACKGROUND OF THE INVENTION

Presently, disk drives typically have two read/write heads for reading/writing data from/onto two sides of two disks. Typically, each of the read/write heads is mounted on a suspension, which suspension is made of flexible material. In addition, loading and unloading of the read/write heads onto the disks typically utilizes a plastic ramp mechanism, which supports tips of the suspensions to (a) provide a parking position for the read/write heads; and (b) guide movement of the read/write heads between non-operational and operational positions.

FIG. 1 shows typical prior art disk drive head stack assembly 10 (HSA 10). As shown in FIG. 1, HSA 10 comprises read/write heads 11₁ and 11₂ which are mounted on suspensions 12₁ and 12₂ so that head-to-head distance 14 between heads 11₁ and 11₂ is only on the order of mils (i.e., thousandths of an inch). In the absence of a significant shock load, heads 11₁ and 11₂ do not contact each other since a ramp mechanism supports suspension tips 13₁ and 13₂ to provide sufficient separation between suspensions 12₁ and 12₂, and thereby read/write heads 11₁ and 11₂. Suspensions 12₁ and 12₂ are made of flexible material, and under a high shock load, suspensions 12₁ and 12₂ tend to flex with a high level of deflection. As a result, heads 11₁ and 11₂ may contact or collide with other. Since heads 11₁ and 11₂ are made of hard and brittle material, such contacts or collisions may cause physical damage that causes them to malfunction when they are loaded onto the disk.

FIG. 2 shows a typical prior art disk drive head disk assembly (HDA) that includes HSA 10 shown in FIG. 1, prior art ramp mechanism 20, and disk 21. As shown in FIG. 2, prior art ramp mechanism 20 provides a parking position for heads 11₁ and 11₂, and it guides the movement of heads 11₁ and 11₂ between non-operational and operational positions. It does this by supporting suspension tips 13₁ and 13₂ on ramps and short web feature 15, which short web feature 15 does not extend between heads 11₁ and 11₂. In a normal non-operational position, suspension tips 13₁ and 13₂ are parked on a flat area of prior art ramp mechanism 20. This keeps heads 11₁ and 11₂: (a) away from disk 21; and (b) from contacting each other. However, under high shock load, even though suspensions tips 13₁ and 13₂ are separated by prior art ramp mechanism 20, suspensions 12₁ and 12₂ may still deflect to such a degree that heads 11₁ and 11₂ collide with each other.

In light of the above, there is a need in the art for a disk drive that solves one or more of the above-identified problems.

### SUMMARY OF THE INVENTION

One or more embodiments of the present invention solve one or more of the above-identified problems. In particular, one embodiment of the present invention is a disk drive comprising: (a) two heads for reading/writing data from/onto a disk; and (b) a ramp mechanism adapted to guide movement of the two heads to/from the disk; wherein the ramp mechanism comprises a separation feature having a portion that extends between the two heads.

### BRIEF DESCRIPTION OF THE DRAWING

FIG. 1 shows a typical prior art disk drive head stack assembly (HSA) that includes two read/write heads that are mounted on two suspensions;

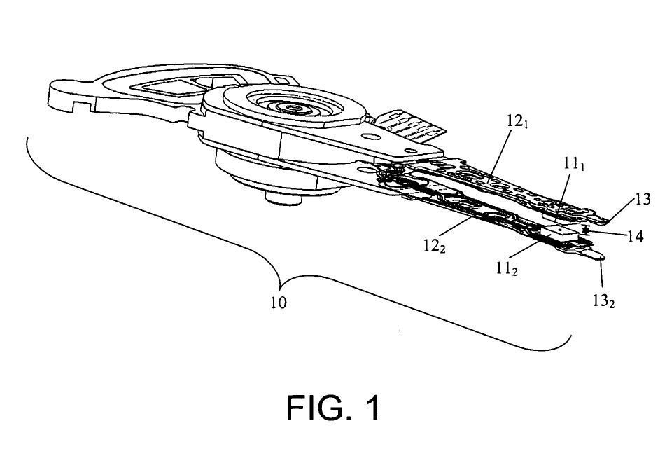

FIG. 2 shows a typical prior art disk drive head disk assembly (HDA) that includes an HSA as shown in FIG. 1;

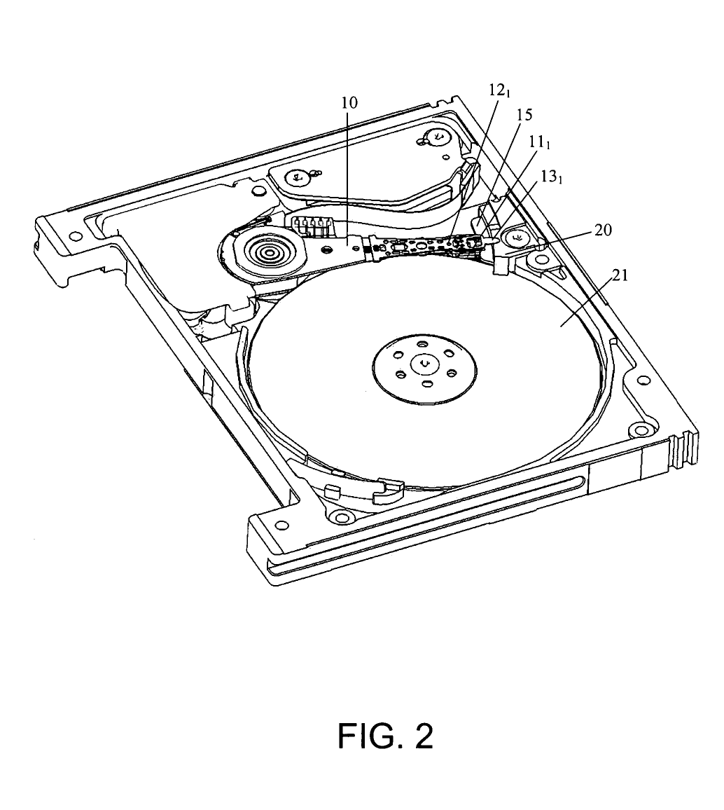

FIG. 3 shows an HDA that is fabricated in accordance with one or more embodiments of the present invention that comprises a separation feature extending between two read/write heads;

FIG. 4 shows a ramp mechanism that is fabricated in accordance with one or more embodiments of the present invention; and

FIG. 5 shows a perspective cut-away view of an HDA that is fabricated in accordance with one or more embodiments of the present invention, which view shows a positional relationship between a separation feature and a read/write head of an HSA.

### DETAILED DESCRIPTION

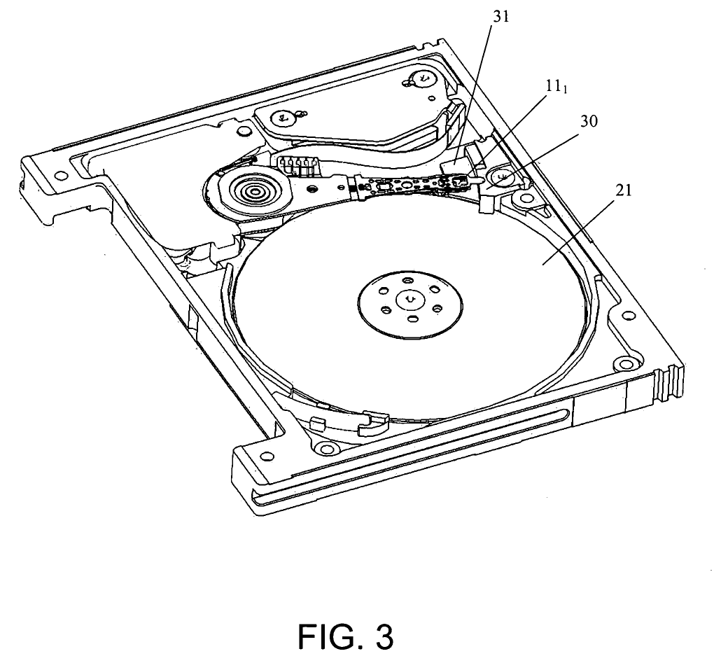

FIG. 3 shows a disk drive head disk assembly (HDA) that is fabricated in accordance with one or more embodiments of the present invention. As shown in FIG. 3, ramp mechanism 30 comprises separation feature 31 that, in accordance with one or more embodiments of the present invention, is an extended web structure that extends from ramp mechanism 30. In accordance with one or more embodiments of the present invention, separation feature 31 is sandwiched between heads 11₁ and 11₂ of a disk drive head stack assembly (HSA), and extends laterally along ramp mechanism 30 from close to one end of ramp mechanism 30 to close to an edge of disk 21. Because separation feature 31 is sandwiched between heads 11₁ and 11₂, separation feature 31 prevents direct contact of heads 11₁ and 11₂, even under high shock load. As a result, use of separation feature 31 solves the problem in prior art disk drives described in the Background of the Invention.

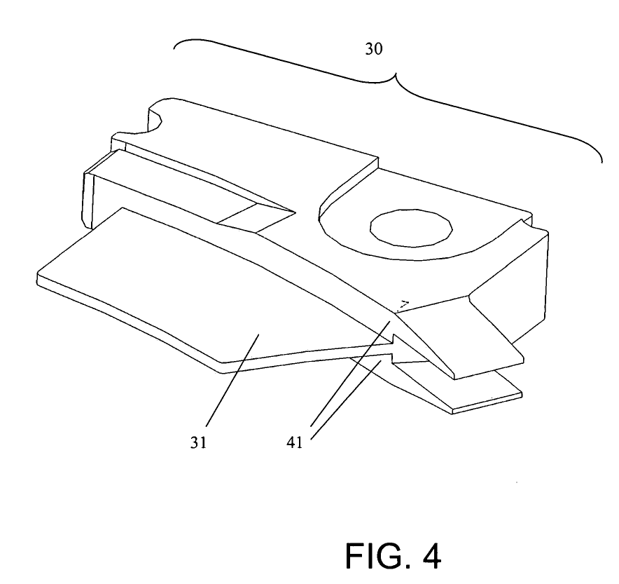

FIG. 4 shows ramp mechanism 30 that is fabricated in accordance with one or more embodiments of the present invention, which ramp mechanism 30 includes separation feature 31. As further shown in FIG. 4, separation feature 31 is an extended web structure that is disposed between ramps 41. In accordance with one or more embodiments of the present invention, separation feature 31 is an extension of, and is fabricated from the same material as, ramp mechanism 30. Further, in accordance with one or more embodiments of the present invention, separation feature 31 comprises a light-weight mesh structure comprised of a stiff material. Still further, in accordance with one or more further embodiments of the present invention, separation feature 31 comprises a collision damping material that absorbs an impact from head 11₁ and/or head 11₂ under high shock load. Still further, in accordance with one or more further embodiments of the present invention, separation feature 31 comprises felt material having cleaning fibers that extend, for example and without limitation, towards (and preferably perpendicularly to) and optionally touching one or more of heads 11₁ and 11₂. Advantageously, in accordance with one or more such embodiments of the present invention, the cleaning fibers enable one or more of heads 11₁ and 11₂ to be cleaned as the one or more of heads 11₁ and 11₂ moves across ramp mechanism 30. Still further, in accordance with one or more further embodiments of the present invention, separation feature 31 comprises a smooth surface.

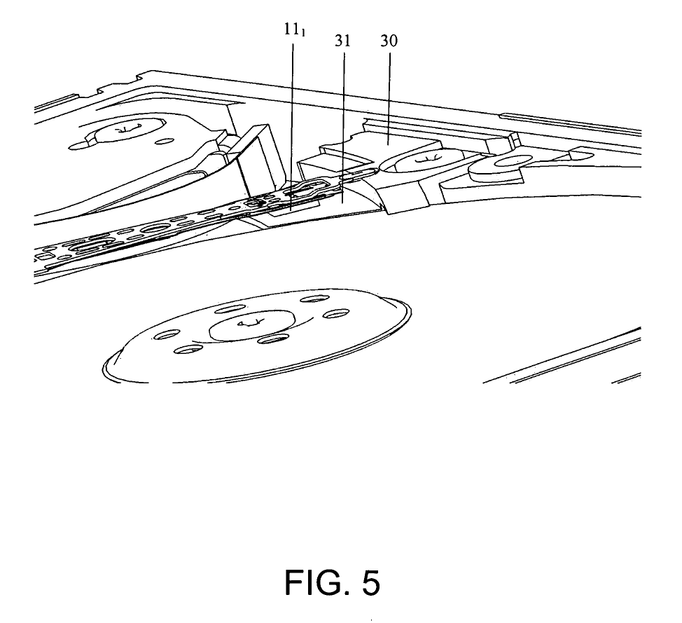

FIG. 5 shows a perspective cut-away view of an HDA that is fabricated in accordance with one or more embodiments of the present invention, which view shows a positional relationship between separation feature 31 (separation feature 31 is sandwiched between heads 11₁ and 11₂) and one of heads 11₁ and 11₂ (the other one of heads 11₁ and 11₂ is disposed under separation feature 31). As shown in FIG. 5, in accordance with one or more embodiments of the present invention, separation feature 31 has a surface area that is larger than a maximum read/write area of each of heads 11₁ and 11₂. Further, in accordance with one or more further embodiments of the present invention, separation feature 31 has a thickness that is adapted to: (a) minimize gaps between separation feature 31 and each of heads 11₁ and 11₂ (thereby minimizing vertical or near-vertical movement of heads 11₁ and 11₂ under shock load); and (b) provide sufficient clearance for heads 11₁ and 11₂ to enable them to move along ramps 41. A suitable thickness for separation feature 31 may be determined routinely by one of ordinary skill in the art without undue experimentation.

Advantageously, a disk drive fabricated in accordance with one or more embodiments of the present invention reduces the likelihood of read/write head damage under high shock load, and therefore: (a) reduces the number of disk drives that are damaged during shipment and handling; and (b) enhances the durability of such disk drives in a mobile use environment.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A disk drive comprising:
two heads for reading/writing data from/onto a disk; and
a ramp mechanism adapted to guide movement of the two heads to/from the disk;
wherein the ramp mechanism comprises a separation feature having a portion that extends between the two heads.

2. The disk drive of claim 1 wherein the separation feature comprises a surface area that is larger than a maximum read/write area of each of the two heads.

3. The disk drive of claim 1 wherein the separation feature comprises an extended web structure.

4. The disk drive of claim 1 wherein the separation feature comprises a mesh structure.

5. The disk drive of claim 1 wherein the separation feature comprises collision damping material.

6. The disk drive of claim 1 wherein the separation feature comprises fibers that extend towards one or more of the two heads.

7. The disk drive of claim 6 wherein one or more of the fibers touch one or more of the heads.

8. The disk drive of claim 6 wherein one or more of the fibers are perpendicular to a read/write surface of one or more of two heads.

9. The disk drive of claim 1 wherein the separation feature comprises a smooth surface.
